(19) United States
(12) Patent Application Publication
(10) Pub. No.: US 2004/0214309 A1
(43) Pub. Date: Oct. 28, 2004

(54) Method for preparing leather using protease and method for treating wastes derived from leather processing

(76) Inventors: Ho-Yong Park, Taejeon-si (KR); Kwang-Hee Son, Taejeon-si (KR); Yong-Kook Kwon, Taejeon-si (KR); Dong-Ha Shin, Taejon-si (KR); Sung-Gi Min, Kyungki-do (KR)

Correspondence Address: BACHMAN & LAPOINTE, P.C., 900 CHAPEL STREET, SUITE 1201, NEW HAVEN, CT, 06510, US

(21) Appl. No.: 10/483,647

(22) PCT Filed: Nov. 14, 2001
(86) PCT No.: PCT/KR01/01942

(30) Foreign Application Priority Data
Jul. 14, 2001 (KR) 2001-42627

(51) Int. Cl. C12S 7/00

(52) U.S. Cl. 435/265; 435/262

(57) ABSTRACT

A sinter metal part with a homogeneous distribution of non-homogeneously melting components, essentially comprising non-homogeneously melting non ferrous metal powder mixtures, produced in the following manner: continuous isostatic pressure sintering of the starting material to obtain densities which substantially correspond to the density of a high-temperature isostatically pressed solid having the same composition, using die in conditions avoiding the occurrence of a liquid phase in powder at temperatures of up to 70% of the metal melting point, preferably up to 60% of the metal melting point, forming a sinter profile substantially possessing a final contour.

### FIELD OF THE INVENTION

The present invention relates to a method for preparing leather using protease HY-3 and a method for treating wastes derived from leather processing using the same. More particularly, the present invention is concerned with a method for preparing leather, in which protease HY-3 produced from Aranicola proteolyticus HY-3 strain is added to the steps of soaking, liming, deliming and bating; and a method for treating wastewater and solid wastes derived from soaking and liming steps, and solid wastes derived from liming, deliming, bating and finishing steps, using the protease HY-3, having advantages of preparing leather of excellent quality, and environmentally friendly treatment or recycling of wastes.

### BACKGROUND OF THE INVENTION

In general, the leather industry, as raw skins processing industry requiring expensive equipment and technique, is the chief industry determining quality of leather articles, such as shoes, bags, clothes and belts. In the leather industry, while the skins or hides of various animals are subjected to complicated leather preparation processes, final product, that is, leather, is produced. Leather preparation processes using physicochemical and biological procedures are classified into water-requiring wet processes and dry processes.

The wet process comprises the steps of brine curing for preventing putrefaction of raw skins by bacteria or molds, soaking for removing needless components of raw skins, liming for producing limed pelt, deliming for removing lime, bating for biologically treating unnecessary components, pickling for decreasing pH, neutralization, retanning, dyeing and fatliquoring.

More specifically, in the soaking step, large quantities of unnecessary proteins attached to raw skins or hides, and salts or dirt, are removed. In the liming step, hairs and nonessential proteins are removed using lime. In the deliming step, the lime used in the previous step is removed. In the bating step for intensive surface cleaning, unnecessary proteins are removed. A hair saving method, which is an environmentally friendly leather preparation method, uses a proteolytic enzyme for the liming and deliming steps. The liming step, among leather preparation processes, largely affects COD (chemical oxygen demand).

Though being a major light industry, the leather industry is a representative industry generating pollutant because of causing water pollution and soil pollution by large quantities of wastewater and solid wastes. Most chemicals used in each step are discharged as wastewater after their use in wet processes.

In order to manufacture leather articles from raw skins, large amounts of chemicals are utilized. Additionally, use is made of large amounts of water, activators, limes, sulfides, salts, acids, chrome, synthetic tannin, dyes, fatliquoring reagents, binders, supplemental agents, brighteners and solvents. However, by overuse of sulfides and alkalis required for removal of various non-structural proteins in raw skins at the liming step, wastewater pollution becomes serious.

In the wastewater produced from the leather preparation, large amounts of organic and inorganic matters, such as high concentrations of salts-including sulfides and organic matters are contained, thus pollution levels being increased. Additionally, upon leather preparation, the liming, deliming, tanning and dyeing steps require large amounts of water and thus the used water is discharged as wastewater. The discharged wastewater, which contains hide scraps, hairs, soluble proteins and intermediate degradation products with high pollution load, flows into a wastewater reservoir. Such wastewater is characterized in that the highly toxic heavy metal, chrome is present and BOD (biological oxygen demand) and COD are very high, attributed to large quantities of organic and inorganic matters, and floatable substances.

In order to purity the wastewater, various equipment and reagents are demanded and thus high wastewater-treating cost is incurred. Further, various solid wastes of the skins, such as fleshing scrap, pelt scrap, shaving scrap, trimming scrap, generated from the leather preparation processes, equal 50% or more of the weight of the raw skins. The treatment cost for such solid wastes increases production costs.

### SUMMARY OF THE INVENTION

Leading to the present invention, the intensive and thorough research into a leather preparation method and a waste-treatment method, carried out by the present inventors aiming to solve the problems encountered in the prior arts, resulted in the finding that, using proteolytic enzymes, leather is prepared and wastes are treated, whereby leather of superior quality can be obtained, and the wastes from leather processing can be decreased in their amounts and be recycled.

Accordingly, it is an object of the present invention to provide a method for preparing leather using protease HY-3 produced by Aranicola proteolyticus HY-3 strain.

It is another object of the present invention to provide a method for treating wastes derived from leather processing using protease HY-3 produced by Aranicola proteolyticus HY-3 strain.

In an aspect of the present invention, there is provided a method for preparing leather using protease HY-3 produced by Aranicola proteolyticus HY-3 strain.

In another aspect of the present invention, there is provided a method for treating wastes from leather preparation process using protease HY-3 produced by Aranicola proteolyticus HY-3 strain.

### BRIEF DESCRIPTION OF THE DRAWINGS

FIG. 1 is a schematic block diagram showing a preparation process of leather, capable of using protease HY-3 of the present invention.

FIG. 2 is a graph showing protein amounts eluted from leather upon use of protease HY-3 of the present invention;

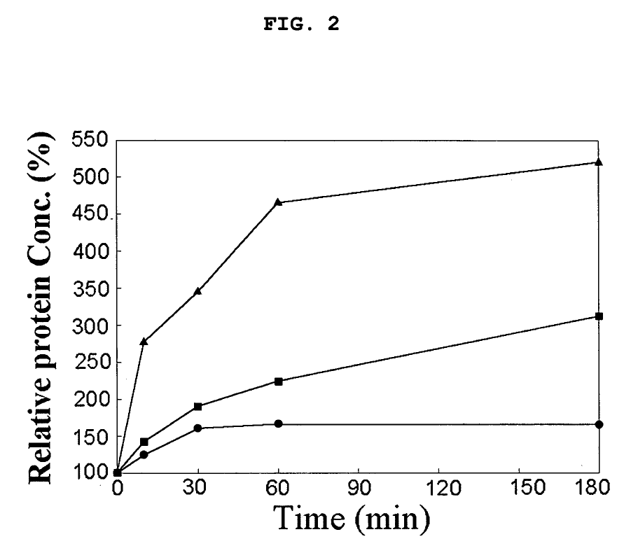

●:control ▪:supernatant ▴:concentrated supernatant

### DETAILED DESCRIPTION OF THE INVENTION

The present invention pertains to a method for preparing leather by use of protease HY-3 produced from Aranicola proteolyticus HY-3 strain.

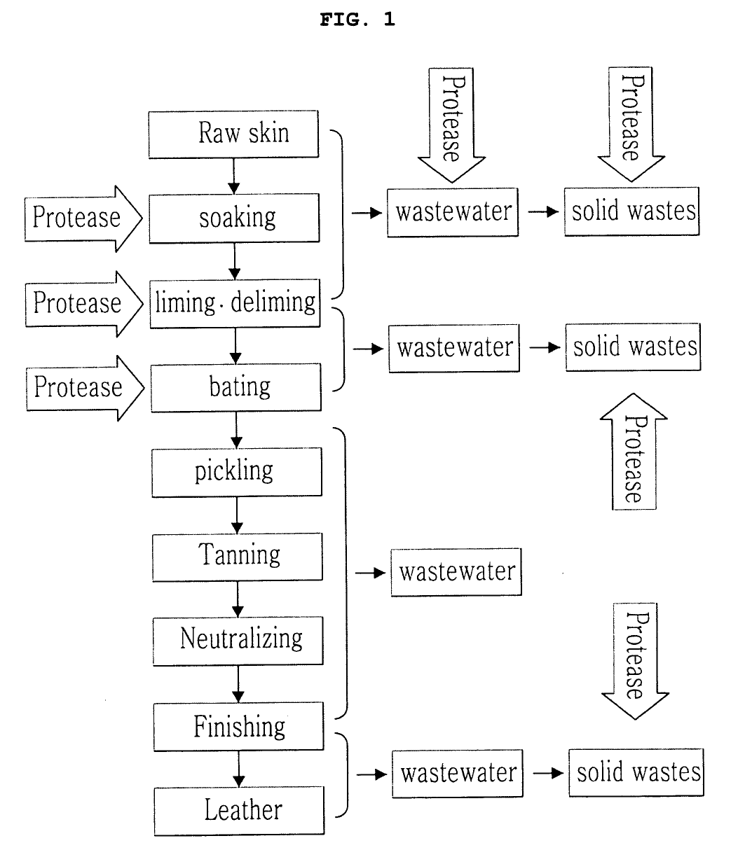

The method of the present invention comprises the steps of soaking, liming, deliming and bating (see FIG. 1).

To prepare the protease HY-3 used for the leather preparation method of the present invention, microorganisms are separated from Aranicola proteolyticus HY-3 strains-cultured medium and thus the remaining enzyme-containing supernatant is used, or a mixture of the protease HY-3 and an additive for increasing stability of the enzyme or a material introduced to each step, formulated in a preparation, is used.

The protease HY-3 of the present invention is preferably added at an amount of 0.1-15 wt % to the steps of soaking, liming, deliming and bating, and is the microorganism-removed enzyme-containing liquid from microorganism culture medium, or may be the preparation mixed with an additive for increasing stability of the enzyme or a material introduced to each step.

The present protease HY-3 has a maximum activity at 37° C. with a relative activity of 75% or more at 20-40° C. In addition, the protease shows a maximum activity at pH 8.0 and a relative activity of 80% or more at pH 7.0-9.5 (Korean Pat. Application No. 2000-5479). Generally, soaking, liming and bating steps are carried out at 25-35° C. and at pH 8-9, so that proteins in the skins can be stably decomposed using the protease HY-3. Also, when large quantities of salts are added to the steps of soaking, liming, deliming and bating, most proteolytic enzymes are decreased in their activity, whereas the present protease HY-3 maintains its activity, even at high salinity of 10%, and thus can be applied to each step.

By using the protease HY-3, conventionally used organic and inorganic chemicals for leather preparation can be drastically decreased in their amounts, and thus environmentally friendly leather-processing can be performed.

Hence, such protease HY-3 can be applied to leather processing, and in particular, be useful in removal of epidermis, hairs and soluble proteins through the steps of soaking, liming, deliming and bating.

In the soaking step, when animal skins or hides subjected to salting treatment are delivered to a leather factory, water should be sufficiently added in a paddle or drum for removing various dirt and unnecessary components, after which water absorbed into skins tissues over a long period of time allows the skins tissues to be restored to the normal skins softness of a live animal. So, unnecessary soluble proteins, dirt and hairs attached to raw skins or hides can be decomposed and then removed by treatment of the protease HY-3. Through such procedure, the skin tissues become smooth and a next liming step can be easily conducted.

In the liming and deliming steps, which strongly affect COD in wastewater generated from the leather processing, the protease HY-3 can decompose cells of stratum germinativum or base cells of hair root, using a principle of decomposing not the cortex but the medulla of hairs. Additionally, hair roots and hair follicles are removed, and thus the trichopore is certainly swelled, and then hairs are eliminated, so that lime and other chemicals can be easily penetrated and thus treatment amounts of chemicals can be reduced.

In the bating step, the protease HY-3 removes unnecessary proteins in raw skins and loosens skin tissues, whereby chemicals for leather processing to be supplied after the bating step can be readily penetrated into the tissues and a bonding strength between chemicals and tissues is increased. Therefore, the required amounts of such chemicals are decreased, and increase of COD and BOD attributed to unbonded chemicals in wastewater is restrained. By use of the protease HY-3, soft and pliable leather can be produced and pollutants on the skins can be removed. Thereby, upon dyeing, the color is improved in dyeing evenness, and thus dyes are decreased in their amounts and leather goods are greatly increased in their quality.

In another embodiment of the present invention, a method for treating wastes derived from leather preparation process using the protease HY-3 is provided.

The wastes produced from the steps of soaking, liming, deliming, bating and finishing are treated by protease HY-3 of the present invention (see, FIG. 1).

The wastes may be formed in liquid or solid state, and also be recycled.

Protease HY-3 applicable to the leather preparation of the present invention is made of a microorganism culture medium, an enzyme-containing liquid remaining after the microorganism is separated from the medium, or a formulated preparation mixed with an additive for increasing stability of the enzyme or a material introduced to each step.

For treatment of the wastes derived from leather preparation process, one selected from the group consisting of a lipase and an amylase is used, together with the protease HY-3.

In order to treat the wastes derived from the leather preparation process, microorganism medium producing the protease HY-3, the enzyme-containing liquid remaining after microorganism is separated from the medium, or the formulated preparation mixed with the additive for increasing stability of the enzyme or the material introduced to each step is added to wastewater and solid wastes generated during the soaking and liming steps, solid wastes generated during the bating step, and solid wastes after the finishing step.

The wastes generated from the leather-preparation amount to 40-70 wt % of the initial weights of raw skins or hides. Most discharged solid wastes are classified as industrial wastes and thus burned up or simply buried. Hence, treatment cost of such solid wastes is considerably high in light of production cost.

The solid wastes, treatable by the protease HY-3, are exemplified by fleshing scraps, trimming scraps and hairs from the raw skins, generated during the soaking and liming steps; pelt scraps, after the bating step; and skin scraps, generated from the finishing step following a final drying.

In fleshing scraps and trimming scraps, proteins and lipids are not completely separated and are present in a mixed state, in which lipid component amounts to 30-50% of total components. To fleshing scraps and trimming scraps, at least one enzyme selected from protease HY-3, lipase and amylase may be added.

The solid wastes, such as pelt scraps which are produced from the bating step after the liming step, comprise about 40% of total wastes generated from leather processing. The pelt scrap comprises 4.0% lipid, 1.5% calcium, 5.5% ash, 50-55% water and 35-40% protein. The protease HY-3 of the present invention, usable as a metallic protease, is increased in its activity when metal ions are present. The activity of the protease HY-3 is increased about 1.5 times in the presence of 1 mM calcium ions, and 1.2-1.4 times in the presence of other metal ions. Metal ions, such as calcium ions, are present in large amounts in the pelt scrap, so that the present protease HY-3 is effective for decomposition of protein in the pelt scraps.

To prepare leather goods from raw skins, large quantities of chemicals should be used. Also, water, activators, limes, sulfides, salts, acids, chrome, synthetic tannin, dyes, fatliquoring agents, binders, supplemental agents, brighteners, and solvents are employed. Overuse of sulfides and alkalis required for removal of various non-structural proteins in raw skins at the liming step causes serious wastewater pollution. The wastewater discharged from the leather processing facilities includes organic, inorganic and floatable matters, and is characterized in that BOD and COD in wastewater is very high and chrome, a heavy metal having high toxicity, is present. By using the protease HY-3, the amounts of activators, limes, sulfides, salts, acids and chrome can be decreased.

Meanwhile, recycling of the wastes using a proteolytic enzyme is reported (Korean Pat. No. 1994-0007333), however, decomposition of proteins in the wastes using a protease-producing microorganism has not been reported yet. The microorganism of the present invention thrives even in the presence of a small amount of carbon source and nitrogen source, and protease HY-3 secreted from such microorganism can decompose the solid wastes derived from the leather processing. Using the protease HY-3, proteins in the wastes can be hydrolyzed to peptides to make foods, cosmetics and industrial products. Additionally, such protease can be used for saline-containing wastewater generated during the soaking and liming steps, and thus proteins in the wastewater can be recycled by decomposition of protease HY-3.

Further, waste leather can be utilized as feed and edible gelatin by cleavage of polypeptide chains in collagen molecules. By using the protease HY-3 for treatment of solid leather wastes, environmental pollution is prevented and secondary products can be obtained.

### EXAMPLES

A better understanding of the present invention may be obtained in light of the following examples which are set forth to illustrate, but are not to be construed to limit the present invention.

### EXAMPLE 1

### Production of Protease HY-3

In order to produce protease HY-3, a standard medium for growth of microorganism was sterilized under high pressure at 121° C. for 20 minutes, and then Aranicola proteolyticus HY-3 strain (KCTC 0268BP) producing potease HY-3 was added in the amount of 0.1-5 vol % on the basis of the whole volumes of the medium and cultured at 25-30° C. for 25-30 hours. The medium was subjected to membrane filtration and thus supernatant was separated from the biomass. As necessary, the supernatant was concentrated 3-10 times through 10 kDa membrane filtration.

### EXAMPLE 2

### Analysis of Protein Eluted From Liming and Deliming Steps Using Protease HY-3

In order to investigate the effect of protease HY-3 at liming and deliming steps greatly affecting COD, the following procedure was carried out.

In specifically, 20 g of skin was cut to suitable sizes, and introduced into 50 ml tubes, and then 10 ml of water was added thereto. Thereafter, 0.5% sodium bisulfite and 0.5% ammonium sulfate were added and reacted at room temperature for 15 minutes. After reaction, 0.2% detergent and 0.5% degreasing agent were added to the resulted solution and reacted at room temperature for 30 minutes. The three tubes were divided into a control containing no protease HY-3, and supernatant and concentrated supernatant prepared as in the above example 1. Each of tubes was allowed to stand at room temperature, and samples were obtained. Assay of protein eluted from the samples was performed using a protein assay kit (Bio-rad, USA) of modified Bradford method (Bradford, M., Anal. Biochem., 1976, 72, 248).

From the experimental results, it can be seen that tubes containing the protease HY-3 contain more eluted proteins, compared to the control, and also much more proteins are eluted by the concentrated supernatant than by the unconcentrated supernatant of microorganism-cultured medium.

### EXAMPLE 3

### Use of Protease HY-3 at Bating Step

In order to increase stability and performance of the protease HY-3 in leather processing, the protease was formulated in a preparation and thus used at the bating step.

Lyophilized protease HY-3 of the present invention was added in the amount of 0.5-10 wt % to 40-50% ammonium chloride (NH₄Cl), 40-50% ammonium sulfate ((NH₄)₂SO₄), 0.005-0.01% calcium chloride (CaCl₃) and 0.025-0.1% lactose. To examine the bating effect of the formulated protease HY-3, the skins were subjected to deliming step, and then to bating step using different enzyme preparations, after which the skins were observed as to their surface state. In addition, the skins were subjected to tanning and finishing steps, and then the surface state was observed. As the protease preparation used in the bating step for comparison, use was made of Amoron (Chungmu Fermentation, Korea) and Oropon K (TFL, Germany). The experiment procedure is summarized in Table 1, below.

TABLE 1

| Step | Chemicals | % | PH | Time (min) |
|---|---|---|---|---|
| Deliming | H₂O | 200 | | 60 |
| | Deslon | 0.2 | | |
| | NAT (TEXAPEL) | | | |
| | Deliming | 3 | | |
| | Agent | | | |
| Bating | Lactic Acid | 0.2 | 7.6-7.8 | 20 |
| | Bating Agent | 0.1-15 | | 60 |
| Pickling | H₂O | 150 | 2.8-3.0 | 10 |
| | NaCl | 8 | | |
| | HCOOH (1:10) | 0.5 | | 20 |
| | HCOOH (1:10) | 0.5 | | 20 |
| | H₂SO₄ | 0.8 | | 100 |
| | | | | Overnight |
| Tanning | Cr | 3 | 3.6-3.8 | 60 |
| | Cr | 3 | | 60 |
| | Na₂CO₃ | 0.3 | | 20 |
| | Na₂CO₃ | 0.3 | | 20 |
| | Na₂CO₃ | 0.4 | | 540 |

Natural Dry

The present protease HY-3 and controls (Amoron and Oropon K) were added at the bating step. More specifically, at the deliming step, chemicals shown in the table 1 were added for 1 hour and then 0.2 wt % lactic acid and 0.1-15 wt % protease were added at the bating step. The bating step was carried out for 80 minutes, and then the pickling step for treating with strong acid chemicals containing saline matter was carried out for 12 hours or longer and the chrome-containing tanning step was performed for about 12 hours, followed by drying the skins. Thereafter, the skins were observed.

To compare the effect of the used enzyme preparation at each step, the skins were subjected to deliming, bating and pickling steps while using the different enzyme preparations only in the bating step. The skins after bating were observed and the skins of wet-blue state were analyzed.

After bating, the skins treated by the formulated protease HY-3 are clearer and smoother in grain and surface of perioplie corium, compared to controls. As for wet-blue grain, the skins treated by the protease HY-3 are softer on their surfaces and higher in whiteness.

### COMPARATIVE EXAMPLE 1

### Comparison of Properties of Leather

Prepared By Adding Deliming Agent at Bating Step

In order to investigate the activity of protease HY-3 in the presence of different deliming agents, this example was performed in the same manner as in the table 1, except that each of deliming agents, such as 3 wt % ammonium chloride (NH₄Cl), 3 wt % ammonium sulfate ((NH₄)₂SO₄), and 2 wt % ammonium sulfate ((NH₄)₂SO₄) and 1 wt % ammonium chloride (NH₄Cl), was added in the bating step, and then the protease HY-3 was added thereto. The physical properties of the skins were compared for addition of each deliming agent.

Generally, a deliming agent is added to increase the effect of bating. Upon addition of deliming agent, the effect of protease HY-3 by such deliming agent was examined.

1-1 Addition of Ammonium Chloride

While performing the same procedure as in the table 1, 3 wt % of ammonium chloride (NH₄Cl) was added at the bating step and stirred for 60 minutes. Additionally, each of protease HY-3, Amoron and Oropon K was added. The raw skins were cut to width 30 cm×length 20 cm. As a control, no deliming agent was used at the bating step.

The obtained skins were compared in their properties. The results are given in Table 2, below.

TABLE 2

| | | | Protease | | |
|---|---|---|---|---|---|
| Properties | | Control | HY-3 | Amoron | Oropon K |
| Shrinkage | Width | 20 | 18 | 17 | 20 |
| (%) | Length | 19 | 19 | 19 | 22 |

| | | | | |
|---|---|---|---|---|
| Softness (mm) | 1.9 | 2.6 | 2.8 | 2.1 |
| Tensile Strength | 0.7 | 0.8 | 0.8 | 0.6 |
| (kgf/mm²) | | | | |
| Tear strength | 2.3 | 2.1 | 2.4 | 1.8 |
| (kgf/mm²) | | | | |
| Elongation (%) | 64 | 105 | 89 | 70 |

1-2 Addition of Ammonium Sulfate

While performing the same procedure as in the table 1, 3 wt % ammonium sulfate ((NH₄)₂SO₄) was added at the bating step and stirred for 60 minutes. Additionally, protease HY-3, Amoron and Oropon K were used. The raw skins were cut to width 30 cm×length 20 cm. As a control, the no deliming agent was used in the bating step.

The obtained skins were compared in their properties. The results are given in Table 3, below.

TABLE 3

| | | | Protease | | |
|---|---|---|---|---|---|
| Properties | | Control | HY-3 | Amoron | Oropon K |
| Shrinkage | Width | 23 | 16 | 24 | 23 |
| (%) | Length | 23 | 18 | 22 | 22 |

| | | | | |
|---|---|---|---|---|
| Softness (mm) | 1.7 | 2.4 | 2.2 | 2.1 |
| Tensile Strength | 0.8 | 0.8 | 0.9 | 0.9 |
| (kgf/mm²) | | | | |
| Tear strength | 2.4 | 1.6 | 1.4 | 2.1 |
| (kgf/mm²) | | | | |
| Elongation (%) | 43 | 77 | 76 | 77 |

1-3 Addition of Ammonium Chloride and Ammonium Sulfate

While performing the same procedure as in the table 1, 1 wt % ammonium chloride (NH₄Cl) and 2 wt % ammonium sulfate ((NH₄)₂SO₄) were added in the bating step and stirred for 60 minutes. Also, protease HY-3, Amoron and Oropon K were used. The raw skins were cut to width 30 cm×length 20 cm. As a control, no deliming agent was used in the bating step.

The obtained skins were compared in their properties. The results are given in Table 4, below.

TABLE 4

| | | | Protease | | |
|---|---|---|---|---|---|
| Properties | | Control | HY-3 | Amoron | Oropon K |
| Shrinkage | Width | 16 | 19 | 17 | 19 |
| (%) | Length | 26 | 20 | 25 | 28 |

| | | | | |
|---|---|---|---|---|
| Softness (mm) | 3.1 | 3.8 | 3.3 | 3.2 |
| Tensile Strength | 1.4 | 1.4 | 1.4 | 1.2 |
| (kgf/mm²) | | | | |
| Tear strength | 2.3 | 2.4 | 2.5 | 2.2 |
| (kgf/mm²) | | | | |
| Elongation (%) | 121 | 138 | 113 | 107 |

As stated above, when ammonium sulfate ((NH₄)₂SO₄) was used alone in the bating step, the surface of skins after the Protease HY-3 was used was similar to that of skins after Amoron and Oropon K were used. When ammonium chloride (NH₄Cl) alone and a mixture of ammonium chloride (NH₄Cl) and ammonium sulfate ((NH₄)₂SO₄) were used, the elongation percentage of the skins prepared by the Protease HY-3 was excellent. The skins prepared by the Protease HY-3 had more even surface and clearer grain, compared to Amoron and Oropon K. In terms of shrinkage and softness, the results were similar.

When the protease HY-3 was used only with ammonium sulfate, moderate effects were seen, and the synergic effects were seen when ammonium chloride alone or a mixture of ammonium chloride and ammonium sulfate were added.

### COMPARATIVE EXAMPLE 2

### Measurement of Properties of Practically Used Skin

A piece of skin having a thickness of 1.2-1.4 mm, subjected to liming step, was divided into two pieces, one of which was added with protease HY-3 and the other of which was added with an imported bating agent. Then, bating was conducted. The skins were made to crust (that is, subjected to a tanning process to prepare skins ready for making leather goods (e.g., handbag and shoes)), which was then subjected to the method as in the following table 5. The surface state of skins was observed and physical strength of skins was measured.

TABLE 5

| | | | Time | |
|---|---|---|---|---|
| Step | Chemicals | % | (min) | PH |
| Deliming | H₂O (30° C.) | 200 | | |
| | Deslon/NAT (TEXAPEL) | 0.2 | | |
| | (NH₄)₂SO₄ | 2 | | |
| | NH₄Cl | 1 | 60 | 7.6 |
| Bating | Lactic acid | 0.3 | 20 | |
| | Bating Agent | 0.8 | 60 | |

Dry

When the protease HY-3 and the imported Oropon K were used, the properties for skins are shown in Table 6, below.

TABLE 6

Agent

| | |
|---|---|
| Protease HY-3 | Oropon K |

| | | |
|---|---|---|
| Thickness | 1.2-1.4 | 1.2-1.4 |

| | | | |
|---|---|---|---|
| Tensile | Head | 2.7 | 1.1 |
| Strength | Medium | 2.5 | 2.4 |
| (kg/mm²) | Terminal | 2.5 | 1.9 |
| Tear | Head | 5.8 | 4.1 |
| Strength | Medium | 5.1 | 5.1 |
| (kg/mm²) | Terminal | 7.3 | 5.8 |
| Bursting | Head | 40 or more | 32 |
| Strength | Medium | 40 or more | 40 or more |
| (kg/mm²) | Terminal | 40 or more | 37 |
| Elongation | Head | 76 | 59 |
| (%) | Medium | 77 | 82 |
| | Terminal | 60 | 70 |
| Softness | Head | 3.9 | 4.2 |
| (mm) | Terminal | 3.9 | 3.7 |
| | Medium | 3.3 | 3.5 |

From the results of the table 6, it can be seen that the protease HY-3 is more excellent in almost all properties than the imported Oropon K. In the tensile strength, leather treated the protease HY-3 was 2.5-2.7 kg/mm² while leather treated the Oropon K was 1.1-2.4 kg/mm². In the tear strength, the former was 5.1-7.3 kg/mm² while the latter was 4.1-5.8 kg/mm². Also, in the bursting strength, the former was 40 kg/mm² or larger while the latter was 32-40 kg/mm². As for elongation percentage and softness, leather treated the Oropon K was shown as 59-82% and 3.5-4.2%, whereas the protease HY-3 of the present invention produced leather of 60-77% elongation percentage and 3.3-3.9% softness.

### COMPARATIVE EXAMPLE 3

### Protein Decomposition by Protease HY-3

In order to compare protein decomposition by protease HY-3 produced from Aranicola proteolyticus HY-3 strain (KCTC 0268BP) with that of other protease, the protease HY-3 of the present invention and the imported Oropon K were used. Oropon K, as a pancreatic enzyme preparation, is widely used for increasing tensile strength and softness of grain and maintaining soft grain by decomposing collagen without damaging the grain of leather.

The activity of protease HY-3 was measured by the method as follows (Braun, V. & Schmitz, G., Arch, Microbiol. 1980, 124: 55-61). 0.24 g of azo-casein (Sigma, USA) was dissolved in 10 ml of 50 mM phosphate buffer, pH 7.5, to prepare a substrate solution. 300 μl of substrate solution was mixed with 100 μl of culture medium and reacted at 37° C. for 30 minutes. To the reaction, 300 μl of 10% trichloroacetate was added to further react at room temperature for 1 hour. The resulting reaction was centrifuged at 7,000 rpm and the pellet was separated from the supernatant. 300 μl of supernatant was added with 30 μl of 10% sodium hydroxide and then absorbance was measured at 420 nm. 1 unit of enzyme of the present invention was defined as the amount of enzyme releasing an amount of azo and casein, sufficient to increase absorbance by 1.0 after 1 minute of digestion of azo-casein test substrate, at 37° C. 1 unit of each of protease HY-3 and Oropon K was added to a protein substrate mixture (1 mg/ml) of casein, albumin, hemoglobin and keratin, and a protein substrate mixture (5 mg/ml) of collagen and elastin, and then reacted at 37° C. for 2 hours. Thereafter, using a Bradford method, the amount of protein in samples was measured (see, Table 7). Then, 1 unit of enzyme was defined as the amount required to produce 1 μg protein equivalent from proteolytic digestion of the substrate at 37° C. for 1 minute.

Accordingly, the protease HY-3 of the present invention shows higher decomposition activity against most substrates, exclusive of hemoglobin, than Oropon K. Generally, animal skins comprise structural proteins of collagen, elastin, keratin and so on, and non-structural proteins of albumin, globulin and the like. The protease HY-3 can decompose casein and albumin, which are also present in skins, and in particular, has excellent decomposition activity against keratin, which is a main component of hairs, so that it consequently functions in the liming and deliming steps.

Through digestion for 10 minutes by the protease, keratin and collagen can be decomposed by 40% or more. Proteins excluding hemoglobin were highly decomposed by the Protease HY-3 and the results are presented in Table 7, below.

TABLE 7

| | Relative Decomposition (%) | | | | | | | |
|---|---|---|---|---|---|---|---|---|
| | Protease HY-3 | | | | Oropon K | | | |
| | | 30 | | | 10 | 30 | | |
| Protein | 10 min. | min. | 1 h. | 2 h. | min. | min. | 1 h. | 2 h. |
| Casein | 93 | 94 | 95 | 100 | 65 | 70 | 73 | 85 |
| Albumin | 10 | 14 | 15 | 44 | 0 | 10 | 15 | 17 |
| Hemoglobin | 2 | 4 | 12 | 16 | 0 | 5 | 11 | 17 |
| Keratin | 37 | 40 | 40 | 46 | 17 | 18 | 24 | 34 |
| Collagen | 34 | 63 | 66 | 98 | 2 | 15 | 27 | 41 |
| Elastin | 4 | 13 | 18 | 21 | 1 | 4 | 19 | 20 |

In addition, the protease HY-3 was 4 times more active against collagen, compared to Oropon K. The results are shown in Table 8, below. The structural proteins, constructing most animal skins, are constituted collagen of about 60% or more, and collagen is further present in bones, muscles and tendons. So, it is believed that, if a given protease can effectively decompose collagen, it has excellent effect for leather processing.

TABLE 8

Enzyme Activity (unit/ml)

| Protein | Oropon K | Protease HY-3 |
|---|---|---|
| Casein | 10.9 | 14.8 |
| Albumin | 1.6 | 2.2 |
| Hemoglobin | 0.8 | 0.6 |
| Keratin | 2.8 | 6.2 |
| Collagen | 2.3 | 9.8 |
| Elastin | 0.7 | 2.0 |

### INDUSTRIAL APPLICABILITY

As described above, through the method for preparing leather using protease HY-3 and the method for treating wastes derived from leather processing of the present invention, excellent quality of leather can be obtained and also amounts of chemicals used in leather processing can be drastically decreased, thereby treating or recycling wastes in an environmentally friendly manner.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. Sinter metal part with homogeneous distribution of inhomogeneously melting components, essentially from inhomogeneously melting non-ferrous metal powder mixtures, which can be produced by:
continuous isostatic pressure sintering of the initial material to densities corresponding substantially to the density of a hot isostatically pressed solid optionally of the same composition, through a die plate under conditions that prevent the occurrence of a fluid phase in the powder, at temperatures up to 70% of the metal melting point; preferably up to 60% of the metal melting point, producing a sinter profile having essentially final contour.

2. Sinter metal part according to claim 1, further characterised by: mechanical processing of the sintered profile, such as cutting to product length or height, to produce sinter products.

3. Sinter metal part according to claim 1, characterised by heat treatment of the raw sintered products.

4. Sinter metal part according to claim 1, characterised in that it has an elongation of at least about 150% higher, preferably an elongation of about 120% higher than that of hot sintered parts.

5. Sinter metal parts according to claim 1, characterised in that the initial mixture of the material powder to be sintered essentially consists of metals and metal alloys, as well as small quantities of alloying components, hard materials, carriers of wear and tear, fibres.

6. Sinter metal parts according to claim 1, characterised in that at least one metal has been selected from Al, Ti, Cu, Mg, Be, Ni, Cr, Mo, W, bronze, Nb, Pb Co, Zn.

7. Sinter metal part according to claim 6, characterised in that continuous pressure sintering is carried out under an inert gas like a rare gas, nitrogen, carbon dioxide.

8. Sinter metal part according to claim 1, characterised in that the compact used as the initial product for the continuous cold isostatic pressing has regions with different material compositions.

9. Sinter metal part according to claim 8, characterised in that it has defined regions with different compositions, such as layers, strips, round enclosed shapes, polygons.

10. Process for the manufacture of a sinter metal part close to the final contour according to claim 1, characterised by: production of a powder compact, continuous cold isostatic sintering of the same through a two-sided open mould to form a sintered profile at densities corresponding to the density of the solid body; optionally, cutting of the sintered profile into sintered products, optionally, heat treatment of the sintered products or of the sintered profile and, optionally, finishing of the same.

11. Process according to claim 10, characterised in that finishing includes calibration in a calibration press.
